(19) United States
(12) Patent Application Publication
(10) Pub. No.: US 2007/0154173 A1
(43) Pub. Date: Jul. 5, 2007

(54) Broadcasting receiver and method for recording and reproducing video signal

(75) Inventors: Sang Yeol Kim, Gyeonggi-do (KR); Il Gun Kwon, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/637,111

(22) Filed: Dec. 12, 2006

(30) Foreign Application Priority Data
Dec. 13, 2005 (KR) 10-2005-0122803

(51) Int. Cl. H04N 5/91

(52) U.S. Cl. 386/83; 386/94

(57) ABSTRACT

A broadcasting receiver and method for recording and reproducing a video signal in a digital recording medium are disclosed. A digital/analog broadcasting signal which is directly received via an antenna or a cable, an external video signal (e.g., a HDMI signal, a DVI signal, an YPbPr signal, a RGB signal, or a CVBS signal) input via an external terminal and a video signal having a predetermined format (e.g., 1080i, 720p, 480p, 480i, XGA, SVGA or VGA) can be recorded and a time-shift function may be performed.

This application claims the benefit of Korean Patent Application No. 10-2005-0122803, filed on Dec. 13, 2005, which is hereby incorporated by reference as if fully set forth herein.

### BACKGROUND OF THE INVENTION

1. Field of the Invention

The present invention relates to a broadcasting receiver, and more particularly, to an apparatus and method for recording and reproducing a video signal on/from a digital storage medium.

2. Discussion of the Related Art

Recently, in the digital era, recording/reproducing apparatuses capable of recording/reproducing a video signal without an additional tape, such as a personal video recorder (PVR), are attracting much attention.

The PVR records/reproduces a video signal in/from a storage medium embedded in a set top box or a television set, such as a hard disc drive (HDD), unlike a video cassette recorder (VCR). For example, the PVR records a broadcasting program transmitted from a broadcasting station in the HDD and reproduces the program from the HDD.

The PVR provides an excellent function such as a time-shift function, an instant replay function during viewing a live program and the other trick play functions as well as a basic function such as a recording function, compared with the existing VCR. When a time shift function key is pressed due to a variety of situations such as a situation that a viewer receives a phone call or goes to a bathroom during viewing a broadcasting program, the received broadcasting program is automatically stored in the HDD. Thereafter, when a play key is pressed, a scene which is paused and stored in the HDD can be viewed. In addition, a play function, a fast forward function, a rewind function and a slow motion function of the broadcasting program which is stored in the HDD or currently being buffered can be performed. A scene which is desired to be displayed again can be repeatedly viewed using the instant replay function and a tedious scene may be skipped.

### SUMMARY OF THE INVENTION

Accordingly, the present invention is directed to a broadcasting receiver and method for recording and reproducing a video signal that substantially obviate one or more problems due to limitations and disadvantages of the related art.

An object of the present invention is to provide a broadcasting receiver and method for recording and reproducing an external video signal input via an external device on/from a digital storage medium.

Another object of the present invention is to provide a broadcasting receiver and method for converting a resolution of a high-definition video signal input via an external device and recording and reproducing the video signal on/from a digital storage medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a broadcasting receiver comprises: a format converter for receiving a high-definition video signal and down-converting a resolution of the high-definition video signal based on whether the high-definition video signal is copy-protected or not; a digital storage medium for storing the video signal down-converted by the format converter; a storage/reproduction control unit for controlling the video signal to be stored in the digital storage medium or the video signal stored in the digital storage medium to be reproduced; and a display processing unit for processing the video signal reproduced by the storage/reproduction control unit to be suitable for a display device and outputting the processed video signal for display.

The high-definition video signal may be input from at least one of an antenna, a cable and an external terminal.

The format converter may control not to perform recording when the high-definition video signal is copy-protected.

The format converter may not perform the down-conversion when the high-definition video signal is copy-protected.

The format converter may comprise: an analog/digital converter for converting an analog high-definition video signal input via an analog external terminal into a digital high-definition video signal and outputting the digital high-definition video signal as a YUV signal; a digital receiving unit for converting a digital high-definition video signal input via a digital external terminal into a YUV signal; a copy protection detecting unit for detecting whether the high-definition video signal output from the analog/digital converter or the digital receiving unit is copy-protected; and a down-converting unit for down-converting the resolution of the video signal which is not copy-protected, according to the result of detection of the copy protection detecting unit.

The storage/reproduction control unit may further comprise an MPEG encoder, and the video signal output from the format converter may be encoded in the MPEG encoder and stored in the digital storage medium.

The digital storage medium may be a hard disc drive (HDD).

The external terminal may be at least one of a component terminal, a RGB terminal, a digital visual interface (DVI) terminal and a high-definition multimedia interface (HDMI) terminal.

In another aspect of the present invention, there is provided a broadcasting receiver comprising: a format converter for down-converting a resolution of a high-definition video signal input via an external terminal when the high-definition video signal is not copy-protected; a digital storage medium for storing the video signal down-converted in the format converter; a storage/reproduction control unit for storing the video signal in the digital storage medium or reproducing the video signal stored in the digital storage medium; and a display processing unit for processing the video signal reproduced by the storage/reproduction control unit to be suitable for a display device and outputting the video signal for display.

The broadcasting receiver may further comprise a digital broadcast processing unit for receiving and demodulating a digital broadcasting signal transmitted via an antenna or a cable, and the digital broadcasting signal processed in the digital broadcast processing unit may be stored in the digital storage medium via the storage/reproduction control unit or may be output to the display device via the display processing unit.

The broadcasting receiver may further comprise an analog broadcast processing unit for receiving and demodulating an analog broadcasting signal transmitted via an antenna into a signal having a CCIR 656 format, and the analog broadcasting signal processed in the analog broadcast processing unit may be encoded in an MPEG encoder included in the storage/reproduction control unit and may be stored in the digital storage medium or output to the display device via the display processing unit.

In another aspect of the present invention, there is provided a method of recording and reproducing a video signal in a broadcasting receiver including a digital storage medium, comprising: (a) receiving a high-definition video signal and down-converting a resolution of the high-definition video signal based on whether the high-definition video signal is copy-protected or not; (b) controlling the down-converted video signal to be encoded and stored in the digital storage medium or the video signal stored in the digital storage medium to be reproduced; and (c) decoding the video signal reproduced from the digital storage medium, processing the video signal to be suitable for a display device, and outputting the processed video signal.

The step (a) may comprise controlling not to perform recording when the high-definition video signal is copy-protected.

The step (a) may comprise allowing the down-conversion to be not performed when the high-definition video signal is copy-protected.

The step (a) comprises digitalizing the high-definition video signal, converting the high-definition video signal into a YUV signal, and down-converting the YUV signal when the high-definition video signal is an analog signal.

The step (a) may comprise converting the high-definition video signal into a YUV signal and down-converting the YUV signal when the high-definition video signal is a digital signal.

In another aspect of the present invention, there is provided a method of recording and reproducing a video signal in a broadcasting receiver including a digital storage medium, comprising: (a) receiving a high-definition video signal and down-converting a resolution of the high-definition video signal based on a value set by a user; (b) controlling the down-converted video signal to be encoded and stored in the digital storage medium or the video signal stored in the digital storage medium to be reproduced; and (c) decoding the video signal reproduced from the digital storage medium, processing the video signal to be suitable for a display device, and outputting the processed video signal.

In another aspect of the present invention, there is provided a method of recording and reproducing a video signal in a broadcasting receiver including a digital storage medium, comprising: (a) receiving a high-definition video signal and down-converting a resolution of the high-definition video signal based on a genre of the video signal; (b) controlling the down-converted video signal to be encoded and stored in the digital storage medium or the video signal stored in the digital storage medium to be reproduced; and (c) decoding the video signal reproduced from the digital storage medium, processing the video signal to be suitable for a display device, and outputting the processed video signal.

In another aspect of the present invention, there is provided a method of recording and reproducing a video signal in a broadcasting receiver including a digital storage medium, comprising: (a) receiving a high-definition video signal, selecting data information of the video signal, and down-converting a resolution of the video signal; (b) controlling the down-converted video signal and the selected data information to be encoded and stored in the digital storage medium or the video signal stored in the digital storage medium to be reproduced; and (c) decoding the video signal reproduced from the digital storage medium, processing the video signal to be suitable for a display device, and outputting the processed video signal.

In another aspect of the present invention, there is provided a method of recording and reproducing a video signal in a broadcasting receiver including a digital storage medium, comprising: (a) receiving a high-definition video signal, down-converting a resolution of the video signal, and generating video information corresponding to the video signal; (b) controlling the down-converted video signal and the generated video information to be encoded and stored in the digital storage medium or the video signal stored in the digital storage medium to be reproduced; and (c) decoding the video signal reproduced from the digital storage medium and the video information retrieved from the digital storage medium, processing the video signal to be suitable for a display device, and outputting the processed video signal.

In another aspect of the present invention, there is provided a method of recording and reproducing a video signal in a broadcasting receiver including a digital storage medium, comprising: (a) receiving a high-definition video signal and down-converting the high-definition video signal into a video signal having a resolution set by a user; (b) displaying the down-converted video signal and the high-definition video signal in a preview form; (c) detecting a confirmation signal of the down-converted video signal and controlling the down-converted video signal to be encoded and stored in the digital storage medium or the video signal stored in the digital storage medium to be reproduced; and (d) decoding the video signal reproduced from the digital storage medium, processing the video signal to be suitable for a display device, and outputting the processed video signal.

The step (b) may comprise displaying the video signals by an on screen display (OSD) method.

In another aspect of the present invention, there is provided a method of recording and reproducing a video signal in a broadcasting receiver including a digital storage medium, comprising: (a) receiving a high-definition video signal and down-converting the high-definition video signal into a video signal having a selected resolution; (b) controlling the down-converted video signal and data capacity information of the video signal to be encoded and stored in the digital storage medium or the video signal stored in the digital storage medium to be reproduced; and (c) decoding the data capacity information and the video signal reproduced from the digital storage medium, processing the video signal to be suitable for a display device, and outputting the processed video signal.

The data capacity information of the video signal may be information obtained by comparing and analyzing a data capacity of the high-definition video signal and a data capacity of the down-converted video signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram showing the configuration of an embodiment of a broadcasting receiver capable of recording and reproducing a video signal according to the present invention;

FIG. 2 is a block diagram showing the configuration of a format converter of the video signal according to the present invention;

FIG. 3 is a block diagram showing the configuration of another embodiment of the broadcasting receiver capable of recording and reproducing the video signal according to the present invention; and

FIG. 4 is a flowchart illustrating a method for recording and reproducing the video signal in the broadcasting receiver according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to an apparatus and method for down-converting a resolution of a high-definition video signal input via an external device such as a cable set top box, a satellite set top box and a digital versatile disc (DVD) player and recording and reproducing the video signal on/from a storage medium such as a hard disc drive (HDD). At this time, in the present invention, when the external video signal input via the external device has a resolution of a standard-definition (DS) video signal or is a broadcasting program which is directly received via an antenna or a cable, the external video signal is stored in the HDD without performing the down-conversion.

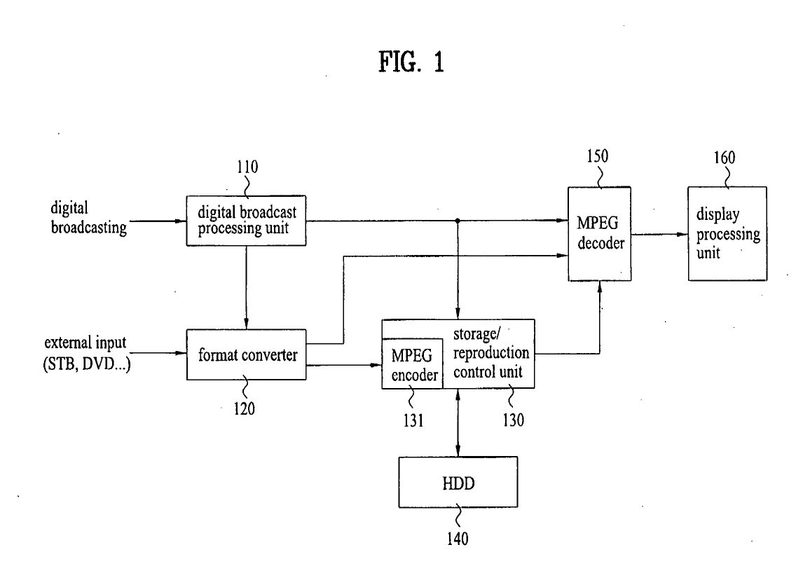

FIG. 1 is a conceptual diagram showing an embodiment of a broadcasting receiver capable of recording and reproducing a video signal according to the present invention, which includes a digital broadcast processing unit 110, a format converter 120, a storage/reproduction control unit 130, a HDD 140, an MPEG decoder 150 and a display processing unit 160. The inputting and processing of an analog broadcasting signal or an external SD video signal are not shown in FIG. 1.

The storage/reproduction control unit 130 includes an MPEG encoder 131.

The digital broadcast processing unit 110 receives and demodulates a digital broadcasting signal transmitted from a broadcasting station and outputs the demodulated signal to the storage/reproduction control unit 130 and the MPEG decoder 150. The format converter 120 outputs a high-definition video signal input via an external device to the MPEG decoder 150 without change or down-converts the resolution of the high-definition video signal and outputs the down-converted video signal to the MPEG encoder 131 included in the storage/reproduction control unit 130. That is, when a signal for displaying an external video is input by a user, the external high-definition video signal is output to the MPEG decoder 150 without down-converting the resolution of the external video signal. When a recording signal is input, the resolution of the external high-definition video signal is down-converted and the down-converted external high-definition video signal is output to the MPEG encoder 131 included in the storage/reproduction control unit 130.

The recording may be any one of reserved recording, immediate recording and time-shift. The recording and the display may be simultaneously selected or only one of the recording and the display may be selected.

The external high-definition video signal is a video signal input via an external device such as a cable set top box, a satellite set top box or a DVD player. At this time, an input/output terminal for connecting the external device to the broadcasting receiver according to the present invention may be a digital input/output terminal such as a digital visual interface (DVI) or a high-definition multimedia interface (HDMI) or an analog input/output terminal such as a component terminal or a RGB terminal. A color space of the input external high-definition video signal may be set to YPbPr or RGB.

A variety of methods for down-converting the resolution of the high-definition video signal in the format converter 120 may be used. The resolution of the down-converted video signal may vary according to the down-converting method. In the present invention, for example, a method for down-converting the resolution of the high-definition video signal into a CCIR 656 format of 480i (i represents interlaced scanning) is described.

The video signal which is down-converted in the format converter 120 is compression-encoded in the MPEG encoder 131 of the storage/reproduction control unit 130 using an MPEG algorithm and stored in the HDD. The storage/reproduction control unit 130 controls the recording and reproduction of the video signal in/from the HDD 140. When the reproduction is selected, the video signal stored in the HDD 130 is read and output to the MPEG decoder 150.

The MPEG decoder 150 receives the compression-encoded video signal output from any one of the digital broadcast processing unit 110, the format converter 120 and the storage/reproduction control unit 130, decodes the video signal by the MPEG algorithm to restore an original video signal, and outputs the original video signal to a display device via the display processing unit 160.

In the present invention, when the input external high-definition video signal is copy-protected, the down-conversion and recording are not performed.

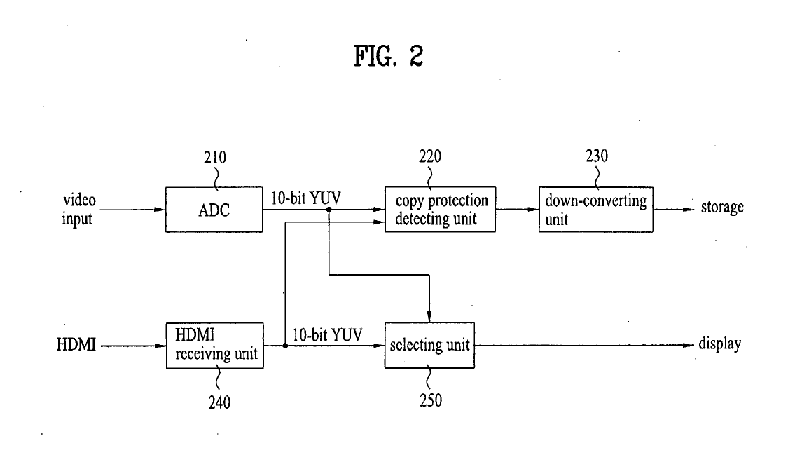

FIG. 2 is a block diagram showing the configuration of the format converter of the video signal according to the present invention. The format converter includes an analog/digital converter (ADC) 210, a copy protection detecting unit 220, a down-converting unit 230, a HDMI receiving unit 240 and a selecting unit 250.

A high-definition video signal which can be generally input via the external terminal is classified into an analog video signal and a digital video signal.

For example, since the video signal input via the DVI terminal or the HDMI terminal is the digital video signal, the video signal does not need to be digitalized. In contrast, since the video signal input via the RGB terminal or the component terminal is the analog video signal, the video signal needs to be digitalized.

The external device, which is connected to the broadcasting receiver for recording/reproducing the video signal via the DVI terminal, the HDMI terminal, the RGB terminal and the component terminal, includes a cable set top box, a satellite set top box, a DVD player and a personal computer (PC).

In the present invention, it is assumed that a digital high-definition video signal is input via the HDMI terminal and an analog high-definition video signal is input via the component terminal. The video signal input via the component terminal is in an YPbPr format.

The video signal input via the HDMI terminal is also called a HDMI signal and the video signal input via the component terminal is also called a component signal.

In this case, the analog high-definition video signal is input to the ADC 210 and the digital high-definition video signal is input to the HDMI receiving unit 240.

The ADC 210 converts the analog high-definition video signal into a digital high-definition video signal and outputs the digital high-definition video signal to the copy protection detecting unit 220 and the selecting unit 250. That is, the ADC 210 converts the analog high-definition video signal into a 10-bit YUV signal and outputs the 10-bit YUV signal to the copy protection detecting unit 220 and the selecting unit 250.

The HDMI receiving unit 240 converts the digital high-definition video signal into a 10-bit YUV signal and outputs the 10-bit YUV signal to the copy protection detecting unit 220 and the selecting unit 250. Here, Y represents a brightness signal and U and V represent color difference signals.

The copy protection detecting unit 220 detects whether the input high-definition video signal is copy-protected, such that the copy-protected video signal is not recorded.

That is, a provider who provides a high-definition video signal may add a copy protection function to the video signal in order to protect copyright on a program represented by the video signal. As an example of the copy protection, a method for inserting a macro-vision signal into the video signal may be used.

When the copy protection detecting unit 220 detects that the input video signal is copy-protected, the down-conversion and the recording of the input video signal are not performed. For example, the video signal output from the ADC 210 or the HDMI receiving unit 240 is not output to the down-converting unit 230 such that the down-conversion and the recording is not performed. Alternatively, the input video signal and the copy protection detecting result are simultaneously output to the down-converting unit 230 such that the down-conversion of the down-converting unit 230 and the recording are not performed.

When the copy protection detecting unit 220 detects that the input video signal is not copy-protected, the input video signal is output to the down-converting unit 230. The down-converting unit 230 down-converts the resolution of the input video signal and outputs the down-converted video signal to the storage/reproduction control unit 130 so as to store the video signal in the HDD. The down-converting unit 230 converts the resolution of the input video signal into the CCIR 656 format. At this time, the copy protection detecting unit 220 and the down-converting unit 230 may be designed to be operated when the recording is selected.

The selecting unit 250 is a processing block which is performed when the display is selected. The selecting unit 250 selects any one or all of the output of the ADC 210 and the output of the HDMI receiving unit 240 according to a display mode (a PIP, a double screen, a POP or the like) and outputs the selected output to the MPEG decoder 150.

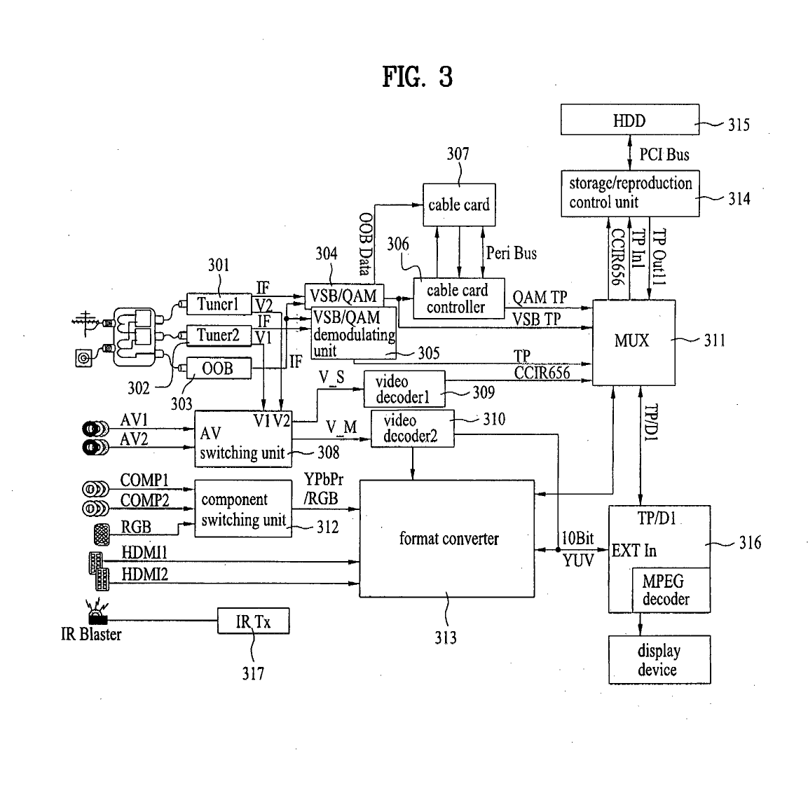

FIG. 3 is a view showing the configuration of another embodiment of the broadcasting receiver capable of recording and reproducing the video signal according to the present invention, in which a HDD is mounted in a digital cable television set. The digital cable television set is a system for allowing terrestrial broadcasting to be viewed without an additional set top box by mounting a cable card and allowing cable broadcasting to be viewed via a cable.

The digital cable television set shown in FIG. 3 includes first and second tuners 301 and 302, an out-of-band (OOB) transmitter/receiver 303, first and second demodulating unit 304 and 305, a cable card control unit 306, a cable card 307, an AV switching unit 308, first and second video decoders 309 and 310, a MUX 311, a component switching unit 312, a format converter 313, a storage/reproduction control unit 314, a HDD 315 and a display processing unit 316. The cable card 307 can be attached/detached.

Data broadcasting of the digital cable television set shown in FIG. 3 uses an OOB scheme. The data broadcasting allows a viewer to select and view a desired program when watching television and allows the viewer to directly participate in a broadcasting program or select and view necessary information.

Referring to FIG. 3, a plurality of external terminals such as a plurality of AV terminals AV1 and AV2, a plurality of component terminals COMP1 and COMP2, a RGB terminal, and a plurality of HDMI terminals HDMI1 and HDMI2 are included. The types and the number of the external terminals are exemplary and a part or all of the external terminals may be included according to the system.

The AV terminals AV1 and AV2 may be connected to a VCR or an analog television set. The component terminals COMP1 and COMP2, the RGB terminal and the HDMI terminals HDMI1 and HDMI2 may be connected to a DVD player, a digital television set, a satellite set top box, a cable set top box or a PC.

The present invention relates to the recording and reproduction of an external video signal input via an external device in/from a HDD. The recording corresponds to any one of immediate recording, reserved recording, time-shift and synchronous recording.

The recording can be performed in the digital cable television set as follows:

1. A vestigial sideband modulation (VSB) type digital video signal which is received via the first and second tuners 301 and 302 and demodulated in the first and second demodulating unit 304 and 305 can be recorded. At this time, the format of the video signal may be 1080i, 720p, 480p or 480i. Here, i represents interlaced scanning and p represents progressive scanning. Both 59.94 Hz and 60 Hz can be supported. 59.94 Hz is the frame rate of an NTSC system.

2. A quadrature amplitude modulation (QAM) type digital video signal which is received via the first and second tuners 301 and 302 and demodulated in the first and second demodulating unit 304 and 305 can be recorded. At this time, the format of the video signal may be 1080i, 720p, 480p or 480i (both 59.94 Hz and 60 Hz can be supported). For example, the digital video signal is a descrambled video signal, that is, a clear channel video signal, and can be viewed and recorded without the cable card 307.

3. A QAM type digital video signal which is received via the first and second tuners 301 and 302, demodulated in the first and second demodulating unit 304 and 305 and descrambled in the cable card 307 can be recorded. At this time, the format of the video signal may be 1080i, 720p, 480p or 480i (both 59.94 Hz and 60 Hz can be supported).

4. An analog composite video banking sync (CVBS) which is received via the first and second tuners 301 and 302 can be recorded. At this time, the format of the video signal may be 480i.

5. A CVBS which is input via the AV terminals AV1 and AV2 can be recorded. At this time, the format of the video signal may be 480i.

6. An external HDMI signal which is input via the HDMI terminals HDMI1 and HDMI2 can be recorded. At this time, if an external device connected to the HDMI terminals HDMI1 and HDMI2 is a digital television set, the format of the video signal may be 1080i, 720p or 480p, and, if the external device is a PC, the format of the video signal may be XGA, SVGA or VGA. In this case, the external HDMI signal is down-converted into a SD signal in the format converter 313 and the down-converted signal is then recorded.

7. An external RGB signal which is input via the RGB terminal can be recorded. At this time, if an external device connected to the RGB terminal is a digital television set, the format of the video signal may be 1080i, 720p or 480p, and, if the external device is a PC, the format of the video signal may be XGA, SVGA or VGA. In this case, the external RGB signal is down-converted into a SD signal in the format converter 313 and the down-converted signal is then recorded.

8. An external YPbPr signal which is input via the component terminals COMP1 and COMP2 can be recorded. The format of the external YPbPr signal may be 1080i, 720p, 480p or 480i (both 59.94 Hz and 60 Hz can be supported). In this case, the external YPbPr signal is down-converted into a SD signal in the format converter 313 and the down-converted signal is then recorded.

In order to allow the video signal to be recorded and displayed, the first and second tuners 301 and 302 tune and output a specific channel frequency in a terrestrial digital broadcasting signal or terrestrial analog broadcasting signal which is transmitted via an antenna and a cable broadcasting signal which is transmitted in-band via a cable.

That is, the first tuner 301 tunes the specific channel frequency in the terrestrial digital audio/video (A/V) broadcasting signal which is transmitted via the antenna or the cable A/V broadcasting signal which is transmitted in-band via the cable, and outputs the tuned signal to the first demodulating unit 304.

At this time, since the terrestrial broadcasting and the cable broadcasting use different transmission methods, the first demodulating unit 304 uses different demodulation methods according to the transmission method. That is, the terrestrial digital A/V broadcasting signal is modulated by a VSB method and the cable A/V broadcasting signal is modulated by a QAM method. Therefore, if the first tuner 301 tunes the channel frequency of the terrestrial broadcasting signal, the first demodulating unit 304 demodulates the signal by the VSB method and, if the first tuner 301 tunes the channel frequency of the cable broadcasting signal, the first demodulating unit 304 demodulates the signal by the QAM method.

Similarly, the second tuner 302 tunes a specific channel frequency in the terrestrial digital A/V broadcasting signal which is transmitted via the antenna or the cable A/V broadcasting signal which is transmitted in-band via the cable and outputs the tuned signal to the second demodulating unit 305. If the second tuner 302 tunes the channel frequency of the terrestrial broadcasting signal, the second demodulating unit 305 demodulates the signal by the VSB method and, if the second tuner 302 tunes the channel frequency of the cable broadcasting signal, the second demodulating unit 305 demodulates the signal by the QAM method. The signals output from the first and second demodulating units 304 and 305 are in transport (TP) stream formats.

If the signals demodulated in the first and second demodulating units 304 and 305 are terrestrial broadcasting signals, the signals are output to the MUX 311 and, if the signals are the cable signals, the signals are output to the cable card 307 via the cable card control unit 306.

The cable card 307 includes a conditional access (CA) system for copy protection and conditional access of higher value-added broadcasting contents and is also called a point-of-deployment (POD) module.

When the cable broadcasting signal is scrambled, the cable card 307 descrambles the cable broadcasting signal by the control of the cable card control unit 306 and outputs the descrambled signal to the MUX 311. If the cable card 307 is not mounted, the signals demodulated by the first and second demodulating units 304 and 305 are output to the MUX 311. In this case, if the cable broadcasting signal is scrambled, the cable broadcasting signal cannot be descrambled and thus normal recording and the display are hard to be performed. In the present embodiment, a descrambling module is included in the cable card 307 and the cable card can be attached/detached in a host (broadcasting receiver). A broadcasting signal transmitted from a broadcasting station is descrambled by the descrambling module of the cable card and provided to the user. However, in any embodiment, the descrambling module may be included in the host without the cable card. The descrambling module may be downloaded from a broadcasting station. That is, the descrambling module downloaded from the broadcasting station may have a different configuration which can be stored in a memory in the host. The descrambling module may be downloaded by automatically downloading a CA image from the broadcasting station when a security processor embedded in the set top box is connected to a network. It is apparent that such a configuration is also included in the technical range of the present invention.

The data broadcasting signal transmitted via the cable using the OOB scheme is received by the transmitter/receiver 303 and QPSK-demodulated by the first or second demodulating unit 304 or 305 and the demodulated signal is output to the cable card 307. In contrast, user information or system state information is transmitted from the OOB transmitter/receiver 303 to the cable broadcasting station.

The first and second tuners 301 and 302 tune the specific channel frequency of the analog AV CVBS transmitted via the antenna and output the tuned signal to the AV switching unit 308.

The AV switching unit 308 selects at least one of first and second analog broadcasting signals V1 and V2 tuned by the first and second tuners 301 and 302 and first and second external video signals input via the AV terminals AV1 and AV2, outputs the selected signal to the first video decoder 309 for recording, and outputs the selected signal to the second video decoder 310 for display. The first video decoder 309 converts the input analog signal into a signal having a CCIR 656 format and outputs the converted signal to the MUX 311, and the second video decoder 310 converts the input analog signal into a 10-bit YUV signal and outputs the 10-bit YUV signal to the display processing unit 316.

The component switching unit 312 selects one of the analog YPbPr signals input via the component terminals COMP1 and COMP2 and the analog RGB signal input via the RGB terminal and outputs the selected signal to the format converter 313.

The external HDMI signal inputs via the HDMI terminals HDMI1 and HDMI2 are directly output to the format converter 313.

The format converter 313 down-converts the input external video signal into a signal having the CCIR 656 format of 480i and outputs the converted signal to the MUX 311 for recording. At this time, if the external video signal is the YPbPr or RGB signal, the external video signal is digitalized and down-converted into the signal having the CCIR 656 format. The format converter 313 converts the external video signal into the 10-bit YUV signal and outputs the 10-bit YUV signal to the display processing unit 316 for display. For example, the format converter 313 determines that the input video signal is copy-protected (or recording protected) when detecting a copy generation management system (CGMS) used in a digital interface MIDI, a digital versatile disc (DVD), a digital video cassette (DVC) and the digital broadcasting, regardless of a package broadcasting network. The CGMS represents a technology for controlling the number of copies using software in order to protect the copyright on the macro-vision signal or digital contents of the input video signal.

At this time, when the external video signal is copy-protected, the external video signal is not down-converted and output to the MUX 311. This is because the copy-protected video signal must not be recorded due to the copyright.

The MUX 311 selects a video signal selected by the user from the plurality of input signals, that is, the input video signals via the first and second demodulating units 304 and 305, the cable card 307, the first video decoder 309 and the format converter 313 and outputs the selected signal to the storage/reproduction control unit 314.

The storage/reproduction control unit 314 stores the video signal input via the MUX 311 in the HDD 315 by a recording command and reads and outputs the video signal stored in the HDD 315 to the MUX 311 by a reproduction command.

At this time, the storage/reproduction control unit 314 includes an MPEG encoder (not shown) If necessary, the input video signal is encoded in the MPEG encoder using an MPEG2 algorithm and stored in the HDD 315. For example, when the video signal is received from the first video decoder 309 or the format converter 313 via the MUX 311, the video signal is converted into a signal having the MPEG2 TP format in the MPEG encoder and stored in the HDD 315.

If the recording mode selected by the user is a time-shift mode, the storage/reproduction control unit 314 receives the broadcasting signal selected by the user via the MUX 311 and stores the broadcasting signal in the HDD 315. Thereafter, the storage/reproduction control unit 314 reads the video signal stored in the HDD 315 and outputs the video signal to the display processing unit 316 via the MUX 311 in a first-in-first-out order after a predetermined time elapses.

The MUX 311 receives the video signal stored in the HDD 315 via the storage/reproduction control unit 314 and outputs the video signal to the display processing unit 316. The MUX 311 selects at least one of the video signals input via the first and second demodulating units 304 and 305 and the cable card 307 and outputs the selected signal to the display processing unit 316 for display.

The display processing unit 316 processes the video signal output from the MUX 311 or the format converter 313 to be suitable for the display device and outputs the processed signal to the display device. At this time, the display processing unit 316 includes an MPEG decoder. If the video signal output from the MUX is MPEG-encoded, the video signal is MPEG-decoded and then processed to be suitable for the display device.

In the present invention, after the resolution of a high-definition video signal input via an external device such as a satellite set top box, a cable set top box and a DVD player is down-converted, and the high-definition video signal is recorded.

The present invention further includes an IR transmission unit 317. The digital cable television set can control the power ON/OFF and the channel UP/DOWN of the satellite set top box, the cable set top box and the DVD player connected to the digital cable television set via an external terminal, using an IR blaster.

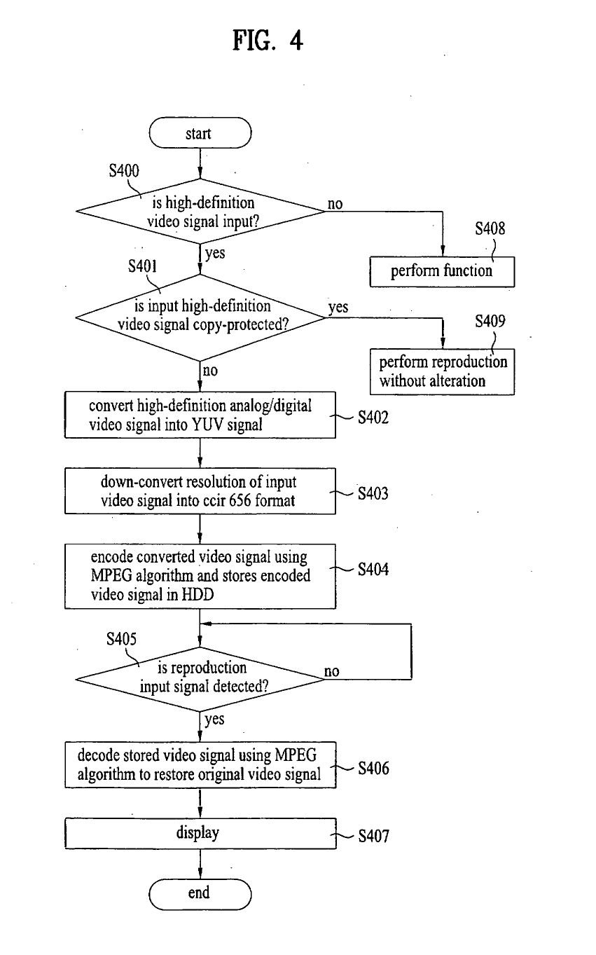

FIG. 4 is a flowchart illustrating a method for recording and reproducing the video signal in the broadcasting receiver according to the present invention.

The broadcasting receiver receives a high-definition video signal from an external device, for example, via a cable set top box, a satellite set top box or a DVD player (S400). At this time, an input/output terminal for connecting the external device to the broadcasting receiver according to the present invention may be a digital input/output terminal such as a DVI or a HDMI or an analog input/output terminal such as a component terminal or a RGB terminal. The color space of the input external high-definition video signal is set to YPbPr or RGB.

The recording of the high-definition video signal according to the embodiment of the present invention may be any one of reserved recording, immediate recording and time-shift. The recording and the display may be simultaneously selected or only any one of the recording and the display may be selected. First, if the input high-definition video signal includes a macro-vision or is copy-protected by the CGMS, the down-conversion and the recording are not performed (S401 and 409).

When the input high-definition video signal is an analog signal, the high-definition video signal is digitalized and color-converted into a YUV signal, and, when the input high-definition video signal is a digital signal, the high-definition video signal is color-converted to the YUV signal (S402). The YUV scheme represents color with a brightness signal Y, a difference U in red and a difference V in blue, and Y:U:V is 4:2:2. The YUV is expressed by Y=0.3R+0.59G+0.11B, U=(B−Y)*0.493 and V=(R−Y)*0.877, which is obtained by color-converting the RGB value.

The resolution of the high-definition video signal converted into the YUV signal is down-converted into the resolution of the SD video signal (S403). At this time, a variety of methods for down-converting the resolution of the high-definition video signal may be used in the format converter. The resolution of the down-converted video signal may vary according to the down-converting method. In the present invention, the down-conversion of the resolution of the video signal into a CCIR 656 format of 480i (i represents interlaced scanning) is performed.

The down-converted video signal is encoded in the MPEG encoder using an MPEG algorithm and stored in the HDD (S404). After recording, a reproduction input signal is detected and the stored video signal is decoded using the MPEG algorithm to restore an original video signal (S405 and S406). At this time, the video signal is processed with a display specification and output (S407).

The terminologies used herein are defined in consideration of the functions in the present invention and may be changed according to the intention or usual practice of those skilled in the art. The definitions of the terminologies should be understood based on the general purpose or description of the specification.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A broadcasting receiver comprising:
a format converter for receiving a high-definition video signal and down-converting a resolution of the high-definition video signal based on whether the high-definition video signal is copy-protected or not;
a digital storage medium for storing the video signal down-converted by the format converter;
a storage/reproduction control unit for controlling the video signal to be stored in the digital storage medium or the video signal stored in the digital storage medium to be reproduced; and
a display processing unit for processing the video signal reproduced by the storage/reproduction control unit to be suitable for a display device and outputting the processed video signal for display.

2. The broadcasting receiver according to claim 1, wherein the high-definition video signal is input from at least one of an antenna, a cable and an external terminal.

3. The broadcasting receiver according to claim 2, wherein the external terminal is at least one of a component terminal, a RGB terminal, a digital visual interface (DVI) terminal and a high-definition multimedia interface (HDMI) terminal.

4. The broadcasting receiver according to claim 1, wherein the format converter digitalizes the high-definition video signal, converts the high-definition video signal into a YUV signal, and down-converts the YUV signal when the received high-definition video signal is an analog signal.

5. The broadcasting receiver according to claim 1, wherein the format converter converts the high-definition video signal into a YUV signal and down-converts the YUV signal when the received high-definition video signal is a digital signal.

6. The broadcasting receiver according to claim 1, wherein the format converter comprises:
an analog/digital converter for converting an analog high-definition video signal into a digital high-definition video signal and outputting the digital high-definition video signal as a YUV signal;
a digital receiving unit for converting a digital high-definition video signal input via a digital external terminal into a YUV signal;
a copy protection detecting unit for detecting whether the high-definition video signal output from the analog/digital converter or the digital receiving unit is copy-protected; and
a down-converting unit for down-converting the resolution of the video signal which is not copy-protected, according to the result of detection of the copy protection detecting unit.

7. The broadcasting receiver according to claim 6, wherein the down-converting unit converts the received high-definition video signal into a video signal having a CCIR 656 format.

8. The broadcasting receiver according to claim 6, wherein the down-converting unit further comprises a selecting unit for outputting the YUV signal output from the analog/digital converter and/or the YUV signal output from the digital receiving unit to the display processing unit for display.

9. The broadcasting receiver according to claim 1, wherein the storage/reproduction control unit further comprises an MPEG encoder, and the video signal output from the format converter is encoded by the MPEG encoder and stored in the digital storage medium.

10. The broadcasting receiver according to claim 1, further comprising a broadcast receiving unit for receiving and processing a broadcasting signal transmitted via an antenna or a cable,
wherein the broadcasting signal processed by the broadcast receiving unit is stored in the digital storage medium via the storage/reproduction control unit or is output to the display device via the display processing unit.

11. The broadcasting receiver according to claim 1, wherein the digital storage medium is a hard disc drive (HDD).

12. A method of recording and reproducing a video signal in a broadcasting receiver including a digital storage medium, the method comprising:
(a) receiving a high-definition video signal and down-converting a resolution of the high-definition video signal based on whether the high-definition video signal is copy-protected or not;
(b) controlling the down-converted video signal to be encoded and stored in the digital storage medium or the video signal stored in the digital storage medium to be reproduced; and
(c) decoding the video signal reproduced from the digital storage medium, processing the video signal to be suitable for a display device, and outputting the processed video signal.

13. The method according to claim 12, wherein the step (a) comprises digitalizing the high-definition video signal, converting the high-definition video signal into a YUV signal, and down-converting the YUV signal when the received high-definition video signal is an analog signal.

14. The method according to claim 12, wherein the step (a) comprises converting the high-definition video signal into a YUV signal and down-converting the YUV signal when the received high-definition video signal is a digital signal.

15. The method according to claim 12, wherein the step (a) comprises converting the received high-definition video signal into a video signal having a CCIR 656 format.

16. The method according to claim 12, wherein the step (b) comprises MPEG2-encoding the video signal output in the step (a) and storing the encoded video signal in the digital storage medium.

17. A method of recording and reproducing a video signal in a broadcasting receiver including a digital storage medium, the method comprising:
(a) receiving a high-definition video signal and down-converting a resolution of the high-definition video signal based on a value set by a user;
(b) controlling the down-converted video signal to be encoded and stored in the digital storage medium or the video signal stored in the digital storage medium to be reproduced; and
(c) decoding the video signal reproduced from the digital storage medium, processing the video signal to be suitable for a display device, and outputting the processed video signal.

18. The method according to claim 17, wherein the step (a) comprises converting the received high-definition video signal into a video signal having a CCIR 656 format.

19. A method of recording and reproducing a video signal in a broadcasting receiver including a digital storage medium, the method comprising:
(a) receiving a high-definition video signal and down-converting a resolution of the high-definition video signal based on a genre of the video signal;
(b) controlling the down-converted video signal to be encoded and stored in the digital storage medium or the video signal stored in the digital storage medium to be reproduced; and
(c) decoding the video signal reproduced from the digital storage medium, processing the video signal to be suitable for a display device, and outputting the processed video signal.

20. The method according to claim 19, wherein the step (a) comprises converting the received high-definition video signal into a video signal having a CCIR 656 format.

21. A method of recording and reproducing a video signal in a broadcasting receiver including a digital storage medium, the method comprising:
(a) receiving a high-definition video signal, selecting data information of the video signal, and down-converting a resolution of the video signal;
(b) controlling the down-converted video signal and the selected data information to be encoded and stored in the digital storage medium or the video signal stored in the digital storage medium to be reproduced; and
(c) decoding the video signal reproduced from the digital storage medium, processing the video signal to be suitable for a display device, and outputting the processed video signal.

22. The method according to claim 21, wherein the data information of the video signal includes audio information according to a language.

23. A method of recording and reproducing a video signal in a broadcasting receiver including a digital storage medium, the method comprising:
(a) receiving a high-definition video signal, down-converting a resolution of the video signal, and generating video information corresponding to the video signal;
(b) controlling the down-converted video signal and the generated video information to be encoded and stored in the digital storage medium or the video signal stored in the digital storage medium to be reproduced; and
(c) decoding the video signal reproduced from the digital storage medium and the video information retrieved from the digital storage medium, processing the video signal to be suitable for a display device, and outputting the processed video signal.

24. A method of recording and reproducing a video signal in a broadcasting receiver including a digital storage medium, the method comprising:
(a) receiving a high-definition video signal and down-converting the high-definition video signal into a video signal having a resolution set by a user;
(b) displaying the down-converted video signal and the high-definition video signal in a preview form;
(c) detecting a confirmation signal of the down-converted video signal and controlling the down-converted video signal to be encoded and stored in the digital storage medium or the video signal stored in the digital storage medium to be reproduced; and
(d) decoding the video signal reproduced from the digital storage medium, processing the video signal to be suitable for a display device, and outputting the processed video signal.

25. The method according to claim 24, wherein the step (b) comprises displaying the video signals by an on screen display (OSD) method.

26. A method of recording and reproducing a video signal in a broadcasting receiver including a digital storage medium, the method comprising:
(a) receiving a high-definition video signal and down-converting the high-definition video signal into a video signal having a selected resolution;
(b) controlling the down-converted video signal and data capacity information of the video signal to be encoded and stored in the digital storage medium or the video signal stored in the digital storage medium to be reproduced; and
(c) decoding the data capacity information and the video signal reproduced from the digital storage medium, processing the video signal to be suitable for a display device, and outputting the processed video signal.

27. The method according to claim 26, wherein the data capacity information of the video signal is information obtained by comparing and analyzing a data capacity of the high-definition video signal and a data capacity of the down-converted video signal.
